(19) United States
(12) Patent Application Publication
(10) Pub. No.: US 2009/0063278 A1
(43) Pub. Date: Mar. 5, 2009

(54) METHOD AND SYSTEM FOR ADJUSTING QUALITY INDEX AND PROVIDING ADVERTISEMENT USING ADJUSTED QUALITY INDEX

(75) Inventors: Ki Ho SONG, Seoul (KR); Jong Ho PARK, Seoul (KR)

Correspondence Address: EDWARDS ANGELL PALMER & DODGE LLP, P.O. BOX 55874, BOSTON, MA, 02205, US

(73) Assignee: NHN CORPORATION, Seongnam (KR)

(21) Appl. No.: 12/198,968

(22) Filed: Aug. 27, 2008

(30) Foreign Application Priority Data
Aug. 28, 2007 (KR) 10-2007-0086741

(51) Int. Cl. G06Q 30/00; G06Q 90/00

(52) U.S. Cl. 705/14

(57) ABSTRACT

Disclosed is a method and system for adjusting a quality index and providing an advertisement using the adjusted quality index. The method includes adjusting a quality index based on a maximum quality index and minimum quality index among quality indexes of advertisements included in an advertisement region, and providing an advertisement according to the advertisement region based on the adjusted quality index.

### CROSS-REFERENCE TO RELATED APPLICATION

This application claims the benefit of Korean Patent Application No. 10-2007-0086741, filed on Aug. 28, 2007, the entire disclosure of which is incorporated herein by reference.

### BACKGROUND

1. Technical Field

The present disclosure relates to a method and system for adjusting a quality index and providing an advertisement using the adjusted quality index.

2. Background Art

Keyword advertisement denotes a type of advertisement that is configured to display a particular advertisement in a search result page when a key word a user inputs in search for a desired advertisement is matched with a key word an advertiser purchases. For example, when a user enters the term “moving” as a searching keyword, advertisements associated with “packing and moving,” “moving company,” and the like are retrieved. In this instance, in an aspect that such advertisements are displayed for only a person interested in that particular service item, the keyword advertisement is different from an existing banner advertisement. That is, since the advertisement is exhibited only for the person that has interest in a particular product or service item, targeted advertisement is possible and a click rate can be improved.

The keyword advertisement includes cost-per-click (CPC) advertisement and a cost-per-mill (CPM) advertisement. In the CPC advertisement, an advertiser is charged every time a user clicks on a particular advertisement or advertisements regardless of the number of displays thereof. For instance, the advertiser deposits a predetermined amount of money in advance, and a predetermined amount of money is deducted from the deposited money only when an advertisement for the advertiser is displayed at a keyword search result and a user is connected to a linked site through clicking the advertisement. In the CPM advertisement, a flat fee is charged for a predetermined period of time regardless of the number of clicks on the advertisement.

In the conventional keyword advertisement, a ranking of advertisement is determined merely based on a bid amount set for each of various advertisement regions and a corresponding advertisement is displayed according to its ranking. That is, users have no choice but to view advertisements based on bid amounts of advertisers regardless of quality of the advertisement, advertising effect, and the like. Also, advertisers may have to bid for a keyword for each of numerous advertisement regions in order to enable their advertisements to be displayed in various advertisement regions.

The above information disclosed in this Background section is only for enhancement of understanding of the background of the invention and therefore it may contain information that does not form the prior art that is already known in this country to a person of ordinary skill in the art.

### BRIEF SUMMARY

An aspect of the present invention provides a method and system for displaying an advertisement that can unify advertisements displayed in various advertisement regions respectively, and thereby can display the advertisements in the various advertisement regions through a single bid, without a need to provide a plurality of bids.

Another aspect of the present invention also provides a method and system for displaying an advertisement that can reflect the quality of an advertisement and advertising effect in a display ranking of the advertisement to display an advertisement of good quality in an upper ranking, and thereby can provide a user with the advertisement of good quality and increase the number of clicks on the advertisement and also enables an advertiser to display the advertiser's advertisement in a upper ranking with relatively low costs.

Another aspect of the present invention also provides a method and system for displaying an advertisement that can adjust a quality index so as not to exceed a predetermined multiple of a difference between a maximum quality index and minimum quality index in the same advertisement region among quality indexes that affect the determination of a display ranking, thereby allows even a new advertiser or an existing advertiser with a relatively bad result not to be required to bid with an excessive amount of money for obtaining a higher ranking.

According to an aspect of the present invention, there is provided a method for providing an advertising service, including: adjusting a quality index based on a maximum quality index and a minimum quality index among quality indexes of advertisements included in an advertisement region; and providing an advertisement according to the advertisement region based on the adjusted quality index.

According to another aspect of the present invention, there is provided a computer readable record medium recording a program for implementing the above-described method.

According to still another aspect of the present invention, there is provided a system for providing an advertising service, including: a quality index adjusting module to adjust a quality index based on a maximum quality index and a minimum quality index among quality indexes of advertisements included in an advertisement region; and an advertisement providing module to provide an advertisement according to the advertisement region based on the adjusted quality index.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a flowchart illustrating a method for providing an advertisement according to an example embodiment;

FIG. 2 illustrates an example describing a method for calculating a ranking index;

FIG. 3 illustrates an example of advertisements arranged in an advertisement region according to a quality index;

FIG. 4 illustrates an example describing a method for adjusting a quality index; and

FIG. 5 illustrates an example describing a method for providing an advertisement according to an advertisement region based on an adjusted quality index; and

FIG. 6 is a block diagram illustrating an internal configuration of an advertisement providing system according to an example embodiment.

### DETAILED DESCRIPTION

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

The present invention relates to a method and system for providing an advertisement that, while integrally displaying advertisement products using a single product platform, can remove the duplicate display of the same advertisement in various advertisement regions, thereby improving the quality of search results and also can calculate a ranking of an advertisement in further consideration of the quality of the advertisement and the advertising effect and display the advertisement according to the ranking, thereby providing a user with good information and increasing the number of clicks on the advertisement and also enabling an advertiser to display the advertiser's advertisement in the various advertisement regions through a single bid. In this instance, even a new advertiser or an advertiser of an advertisement with a relatively bad result does not to need to bid with an excessive amount of money for higher display ranking.

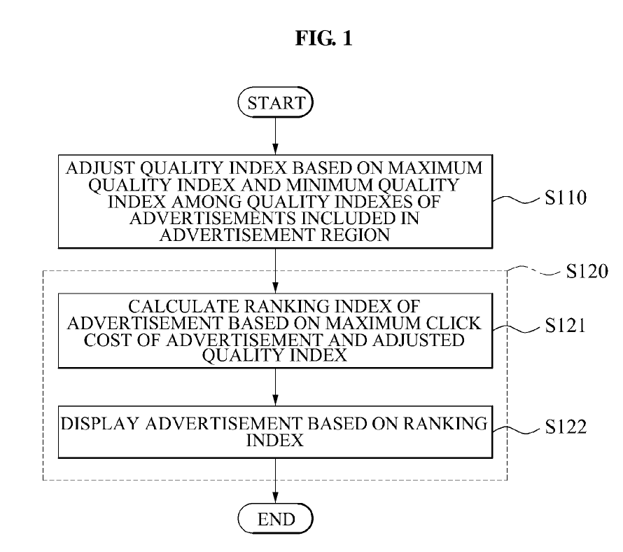

FIG. 1 is a flowchart illustrating a method for providing an advertisement according to an example embodiment.

In operation S110, an advertisement providing system adjusts a quality index based on a maximum quality index and a minimum quality index among quality indexes of advertisements included in an advertisement region. In this case, the quality index is calculated using a quality factor corresponding to a pre-evaluation element and a Click-Through Rate (CTR) corresponding to a post evaluation element with respect to a listing of the advertisement. The quality factor is measured based on at least one of Title & Description (T&D) score associated with the advertisement, a site authority, and a site score. Herein, the elements used for measuring the quality factor are not limited to the T&D score, site authority, and site score, and any index that is previously evaluated by analyzing a pattern of a user can be used. Hereinafter, for ease of description, the above-mentioned three elements are mainly described.

Herein, when the maximum quality index exceeds a predetermined multiple of the minimum quality index, the advertisement providing system may adjust each and every quality index of the advertisement region to be equal to or less than the predetermined multiple. In this instance, each and every quality index of the advertisement region is adjusted may maintain a ratio of a difference between existing quality indexes. Also, the adjusting of the quality index is applied to advertisements displayed more times than a reliable display number before a reference day and the reliable display number is calculated based on the average number of daily queries of a corresponding keyword and the average number of daily displays of the keyword. Conversely, a quality index which the adjusting is not to be applied to is set to be identical to a lowest quality index among adjusted quality indexes of the advertisements displayed more times than the reliable display number before the reference day.

In other words, the advertisement providing system can display the advertisement based on the quality index and also can adjust quality indexes of advertisements displayed more times than the reliable display number before the reference day among the displayed advertisements, thereby making it possible for even a new advertiser or an advertiser of an advertisement with a relatively bad result to get higher ranking without having to pay a significant amount of money.

In operation S120, the advertisement providing system provides an advertisement according to the advertisement region based on the adjusted quality index. That is, for example, the advertisement providing system adjusts quality indexes of advertisements displayed more times than the reliable display number yesterday, for example, thereby being able to provide the advertisement today using the adjusted quality index. As described above, operation S120 may include operations S121 and S122, as shown in FIG. 1, to provide the advertisement based on the adjusted quality index.

In operation S121, the advertisement providing system calculates a ranking index of the advertisement based on the maximum click cost of the advertisement and the adjusted quality index. In this instance, the maximum click cost and adjusted quality index are respectively assigned with a first weight and a second weight and the ranking index is calculated through an operation between the weighted maximum click cost and weight adjusted quality index. For example, the advertisement providing system respectively assigns the first weight to the maximum click cost and the second weight to the adjusted quality index and then multiplies the weighted maximum click cost by the weighted adjusted quality index to calculate the ranking index. Herein, the maximum click cost, which indicates a maximum cost per click on the advertisement, is inputted by an advertiser of the advertisement.

In operation S122, the advertisement providing system displays the advertisement based on the ranking index. In this instance, the advertisement providing system may display an advertisement in a predetermined number in an order of a highest ranking index in each advertisement region. That is, since the display ranking of advertisements is determined through an operation between the maximum click cost and quality index, an advertiser of an advertisement with a low ranking or a new advertiser have no choice but to input a high maximum click cost to raise the ranking of its advertisements when a difference between the quality indexes is significant. That is, the quality indexes can be adjusted in operation S110 such that the difference between the quality indexes may not be excessive by adjusting the maximum quality index not to exceed a predetermined multiple of the minimum quality index in the same advertisement region among quality indexes, thereby enabling even a new advertiser or an advertiser of an advertisement with a relatively bad result to get higher ranking without having to paying an excessive amount of money.

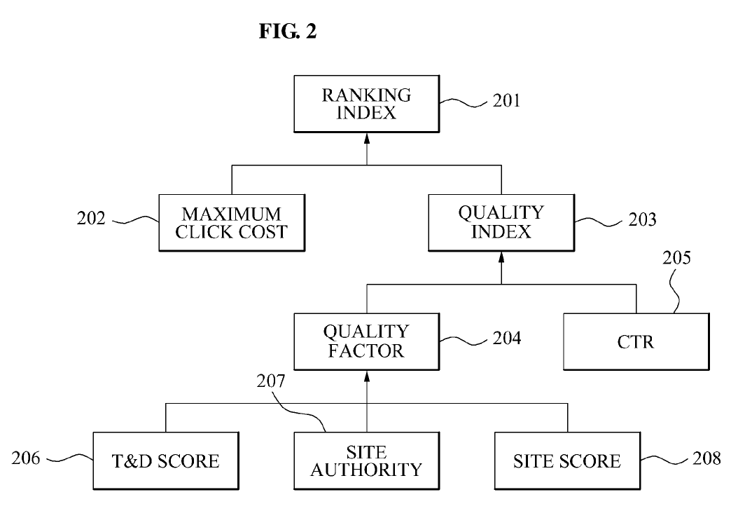

FIG. 2 illustrates an example describing a method for calculating ranking index. In this instance, as shown in FIG. 2, the ranking index 201 may be calculated using a maximum click cost 202 and a quality index 203, and the quality index 203 may be calculated using a quality factor 204 and a CTR 205. Also, the quality factor 204 may be calculated using an index that previously evaluated, by analyzing a pattern of a user, T&D score 206, site authority 207, site score 208, and the like. Herein, the quality index 203 may be an adjusted quality index as described in FIG. 1.

That is, the advertisement providing system, to calculate the ranking index 201, respectively assigns a first and second weight to the maximum click cost 202 and quality index 203 and performs operation between the weighted maximum click cost and the weighted adjusted quality index. For example, the ranking index 201 may be expressed as shown below.

ranking index=(first weight*maximum click cost)*(second weight*quality index) [Equation 1]

The maximum click cost 202 is a maximum cost that an advertiser of an advertisement is willing to pay when the advertisement registered to a keyword is clicked. A minimum of the maximum click cost 202 can be set by setting a minimum bid amount for each keyword that the advertiser may bid.

The quality index 203, as described above, may be calculated based on a combination of a quality factor 204 corresponding to a pre-evaluation element and a CTR 205 corresponding the a post evaluation element with respect to a listing of the advertisement and also may be used to evaluate quality of the listing of the advertisement.

Specifically, the quality index 203 may be calculated by performing an operation between the quality factor 204 assigned with a third weight and the CTR 205 assigned with a fourth weight, and, as an example, may be expressed as shown in Equation 2.

quality index=(third weight*quality factor)+(fourth weight*CTR) [Equation 2]

In this instance, the third weight and the fourth weight may be set such that the sum of the weights has a predetermined integer. For example, the third weight and the fourth weight may be set such that the sum thereof has ‘1.’ The advertisement providing system may adjust a ratio between the third weight and the fourth weight, and thereby assign a weight to the pre-evaluation element or the post-evaluation element. That is, the advertisement providing system provides an advertisement using the initially set third and fourth weight and adjusts the ratio between the third and fourth weight based on a correlation analysis between a quality index 203, CTR 205 and sales of the advertisement.

Also, the quality index 203 is adjusted not to have a predetermined difference between a maximum (quality index) and a minimum (quality index) with respect to a listing of an advertisement displayed according to a corresponding keyword, thereby enabling the quality index to be a more objective value.

The quality factor 204 is measured based on at least one index which is previously evaluated by analyzing a pattern of a user such as the T&D score 206 associated with the advertisement, the site authority 207, the site score 208, and the like. Herein, the elements used for measuring the quality factor are not limited to the T&D score, site authority, and site score, and any index that is previously evaluated by analyzing a pattern of a user can be used. That is, the advertisement providing system may measure the quality factor 204 using any element desired as an occasion demands. When the T&D score 206, site authority (site popularity) 207, and site score 208 are all used, Equation 2 may be expressed as shown in Equation. 3.

quality index=(third weight*((fifth weight*T&D score)+(sixth weight*site authority)+(seventh weight*site score)))+(fourth weight*CTR) [Equation 3]

The T&D score 206, which is a relevance numerical value of the T&D set by an advertiser of the advertisement, may be measured through a first relevance numerical value indicating relevance between a keyword and T&D and a second relevance numerical value indicating relevance between words in the T&D. For example, the T&D score may be measured by a sum of the first relevance numerical value and the second relevance numerical value.

The site authority 207 is in a ranking system based on the number of users' visits, a degree of users' satisfaction, relevance, and the like. Thus, in the case of an advertisement site, since distribution of an advertisement site is insufficient and has a partiality, the site authority 207 can be used to adjust the quality index 203, specifically the quality factor 204 corresponding to a pre-evaluation element.

The site score 208, which is obtained by crawling through the site and measuring relevance between a site and a keyword, may adjust the seventh weight according to a depth of the crawling and technique. For example, Content Match (CM) relevance to a site of an advertiser or a score used for determining a ranking in a search algorithm of a web search can be sued. In the case of using the score used for determining a ranking in the search algorithm, it is possible to use an existing measured score.

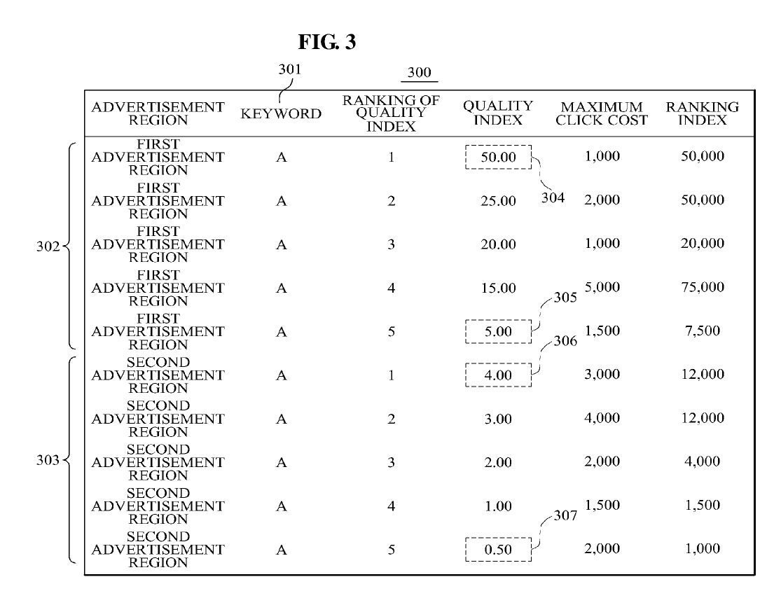

FIG. 3 illustrates an example of advertisements arranged in an advertisement region according to a quality index.

A table 300 shows that advertisements associated with a keyword A 301 are arranged in two advertisement regions, namely, a first advertisement region 302 and a second advertisement region 303 according to a quality index. In this instance, as shown in the table 300, a maximum quality index 304 is ten times a minimum quality index 305 in the first advertisement region 302, and a maximum quality index 306 is eight times a minimum quality index 307 in the second advertisement region 303. That is, an advertiser of an advertisement with the minimum quality index 305, to display his/her advertisement on the first rank in the first advertisement region 302, should bid with a maximum click cost set at least ten times that of an advertiser of an advertisement with the maximum quality index 304. Also, to display an advertisement on the first rank in the second advertisement region 303, an advertiser of an advertisement with the minimum quality index 307 should bid with a maximum click cost set to at least eight times that of an advertiser of an advertisement with the maximum quality index 306.

As described above, there is a problem that a new advertiser or an advertiser of an advertisement (e.g., an advertisement with a low CTR) with a relatively bad result may bid with an excessive amount of money to raise the ranking of its advertisement, more specifically ranking index. According to an aspect of the present invention, this problem is solved by adjusting a quality index in each advertisement region to have difference between a maximum quality index and minimum quality index in a preset range.

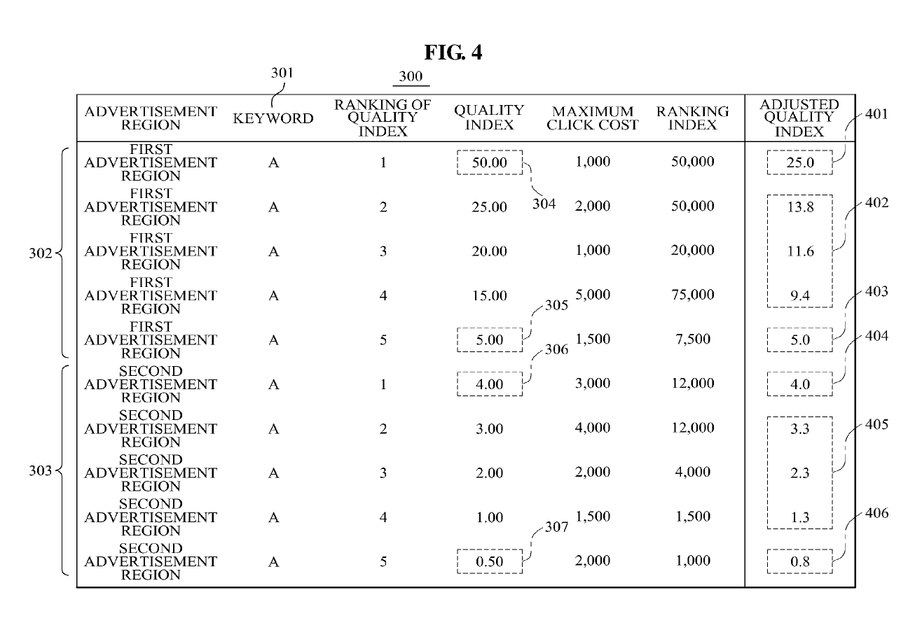

FIG. 4 illustrates an example describing a method for adjusting a quality index.

A table 400 shows an adjusted quality index with respect to a keyword A 301 displayed in two advertisement regions, namely, a first advertisement region 302 and second advertisement region 303. In this instance, the table 400 is an example of adjusting of a quality index to have a maximum quality index not exceeding five times a minimum quality index in the same advertisement region. That is, an adjusted maximum quality index 401 and adjusted minimum quality index 402 in the first advertisement region 302 may respectively indicate quality indexes adjusted to have the maximum quality index 304 not exceeding five times the minimum quality index 305. In this case, quality indexes between the maximum quality index 304 and the minimum quality index 305 may be adjusted to maintain a ratio of a difference between existing quality indexes as shown in quality indexes 403.

In the same manner, an adjusted maximum quality index 404 and adjusted minimum quality index 405 in the second advertisement region 303 may respectively indicate adjusted quality indexes wherein the maximum quality index 306 does not exceed five times the minimum quality index 307. Also, in the same manner, quality indexes between the maximum quality index 306 and the minimum quality index 307 may be adjusted to maintain a ratio of a difference between existing quality indexes as shown in quality indexes 406.

The multiple, ‘5’, used when the adjusting of the difference between the maximum quality index and the minimum quality index in the same region, which is an adjustable value as required, is only an example to describe the present invention, but obviously many modifications and variations by those skilled in the art are possible from the description.

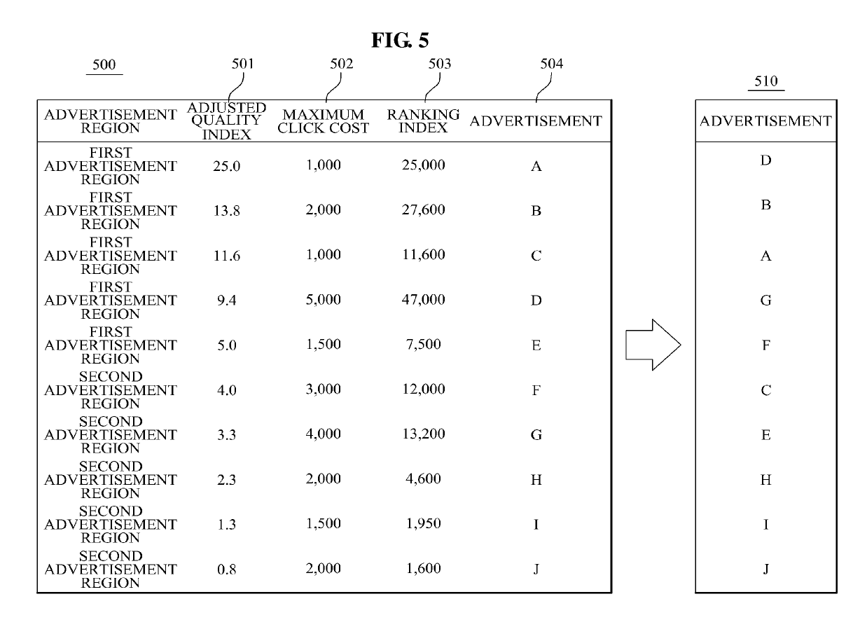

FIG. 5 illustrates an example describing a method for providing an advertisement according to an advertisement region based on an adjusted quality index.

A table 500 shows ranking index 503, which is calculated based on quality index 501 adjusted as described in FIG. 4 and a maximum click cost 502, and corresponding advertisement 504. In this instance, the ranking index 503 in the table 500 is calculated through an operation between the ranking index 503, adjusted quality index 501, and maximum click cost 502. As described above, when the ranking index 503 of advertisement 504 is determined, order of the advertisement 504 to be displayed in two advertisement region, namely, a first advertisement region 302 and second advertisement region 303, is determined based on the ranking index 503.

That is, a table 510 shows advertisements arranged in an order of a highest ranking index. That is, the top five advertisements from among advertisements are sequentially displayed in the first advertisement region 302, and the bottom five advertisements from among advertisements are sequentially displayed in the second advertisement region 303.

As described above, according to a method for displaying an advertisement of the present invention, advertisements can be displayed in the various advertisement regions through a single bid, without a need to provide a plurality of bids for displaying the advertisements in the various advertisement regions, the quality of an advertisement and advertising effect can be reflected in a display ranking of the advertisement, users can be provided with advertisement of good quality, and the number of clicks on the advertisement can be increased. Also, advertisers can display their advertisements in an upper ranking with relatively low costs. Further, even a new advertiser or an advertiser of an advertisement with a relatively bad result can raise its ranking without having to paying an excessive amount of money.

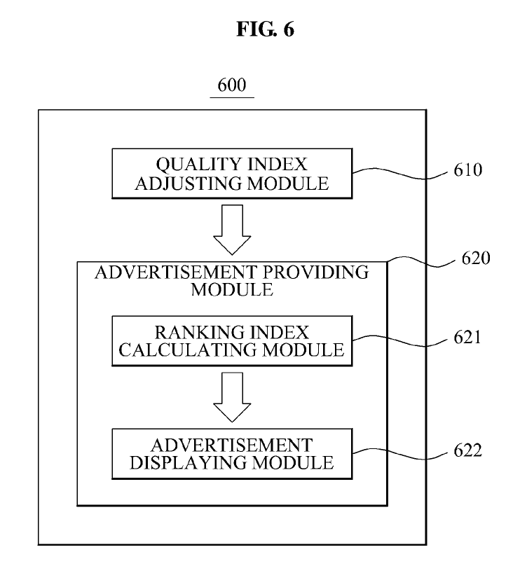

FIG. 6 is a block diagram illustrating an internal configuration of an advertisement providing system according to an example embodiment. As illustrated in FIG. 6, an advertisement providing system 600 may include a quality index adjusting module 610 and an advertisement providing module 620.

The quality index 610 adjusts a quality index based on a maximum quality index and a minimum quality index among quality indexes of advertisements included in an advertisement region. In this instance, the quality indexes may be calculated using a quality factor corresponding to a pre-evaluation element and a CTR corresponding to a post evaluation element with respect to a listing of the advertisement, and also the quality factor is measured based on at least one of T&D score associated with the advertisement, a site authority, and a site score.

Herein, when the maximum quality index exceeds a predetermined multiple of the minimum quality index, the quality index adjusting module 610 may adjust each and every quality index of the advertisement region to be equal to or less than the multiple based on the minimum quality index. In this instance, every quality index of the advertisement region is adjusted to maintain a ratio of a difference between existing quality indexes. Also, the adjusting of the quality indexes is applied to advertisements displayed more times than a reliable display number before a reference day and the reliable display number is calculated based on the average number of daily queries of a corresponding keyword and the average number of daily displays of the keyword. Conversely, quality indexes which the adjusting is not to be applied to are set to be identical to a lowest quality index among adjusted quality indexes of the advertisements displayed more times than the reliable display number before the reference day.

The advertisement providing module 620 provides an advertisement according to the advertisement region based on the adjusted quality index. As an example, the advertisement providing module 620 adjusts quality indexes of advertisements displayed more times than a reliable display number in the previous day or previous days, and thereby can provide the advertisements in the reference (current) day using the adjusted quality indexes. As described above, to provide the advertisement based on the adjusted quality index, the advertisement providing module 620 may include a ranking index calculating module 621 and advertisement displaying module 622.

The ranking index calculating module 621 calculates a ranking index of the advertisement based on the maximum click cost of the advertisement and the adjusted quality index. In this instance, the maximum click cost and adjusted quality index are respectively assigned with a first weight and a second weight and the ranking index is calculated through an operation between the weighted maximum click cost and weight adjusted quality index. For example, the ranking index calculating module 621 respectively assigns the first weight to the maximum click cost and the second weight to the adjusted quality index and then multiplies the weighted maximum click cost by the weighted adjusted quality index to calculate the ranking index. Herein, the maximum click cost, which indicates a maximum cost per click on the advertisement, is inputted by an advertiser of the advertisement.

The advertisement displaying module 622 displays the advertisement based on the ranking index. In this instance, advertisement displaying module 622 may display a particular advertisement in a predetermined number in an order of a highest ranking index in each advertisement region. That is, since the display ranking of the advertisements is determined through an operation between the maximum click cost and quality index, when a difference between the quality indexes is significant, an advertiser of an advertisement with a low ranking or a new advertiser have no choice but to input a high maximum click cost to raise its the ranking of its advertisements. In other words, the advertiser has to bid with an excessive amount of money to raise the ranking of the advertisement. That is, the adjustment of the quality indexes enables the maximum quality index not to exceed a predetermined multiple of the minimum quality index in the same advertisement region among quality indexes by having a difference between the quality indexes not exceed a predetermined value, thereby enabling even a new advertiser or an advertiser of an advertisement with a relatively bad result to raise the ranking of its advertisement without having to pay an excessive amount of money.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and the like, including a carrier wave transmitting signals specifying the program instructions, data structures, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

1. A method for providing an advertising service, comprising:
adjusting a quality index based on a maximum quality index and a minimum quality index among quality indexes of advertisements included in an advertisement region; and
providing an advertisement according to the advertisement region based on the adjusted quality index.

2. The method of claim 1, wherein the quality index is calculated based on a quality factor corresponding to a pre-evaluation element and a Click-Through Rate (CTR) corresponding to a post evaluation element with respect to a listing of the advertisement.

3. The method of claim 2, wherein the quality factor is measured based on at least one of title & description (T&D) score associated with the advertisement, a site authority, and a site score.

4. The method of claim 1, wherein the adjustment of the quality index comprises adjusting, when the maximum quality index exceeds a predetermined multiple of the minimum quality index, each and every quality index in the advertisement region to be equal to or less than the predetermined multiple.

5. The method of claim 4, wherein each and every quality index in the advertisement region is adjusted such that a preset ratio of a difference between existing quality indexes is maintained.

6. The method of claim 4, wherein the quality index is adjusted with respect to advertisements displayed more than a reliable display number before a reference day and the reliable display number is calculated based on the average number of daily queries of a corresponding keyword and the average number of daily displays of the keyword.

7. The method of claim 6, wherein a quality index which is not to be adjusted is set to be identical to a lowest quality index among adjusted quality indexes of the advertisements displayed more than the reliable display number before the reference day.

8. The method of claim 1, wherein the provision of the advertisement comprises:
calculating a raking index of the advertisement based on a maximum click cost of the advertisement and the adjusted quality index; and
displaying the advertisement based on the ranking index.

9. The method of claim 8, wherein the maximum click cost and adjusted quality index are respectively assigned with a first weight and a second weight and the ranking index is calculated through an operation between the weighted maximum click cost and weighted adjusted quality index.

10. The method of claim 8, wherein the maximum click cost, which indicates a maximum cost per click on the advertisement, is inputted by an advertiser of the advertisement.

11. The method of claim 8, wherein the advertisement is displayed in a predetermined number in an order of highest ranking index in each of the advertisement regions.

12. A computer readable record medium recording a program for implementing the method according to claims 1.

13. A system for providing an advertising service, comprising:
a quality index adjusting module to adjust a quality index based on a maximum quality index and a minimum quality index among quality indexes of advertisements included in an advertisement region; and
an advertisement providing module to provide an advertisement according to the advertisement region based on the adjusted quality index.

14. The system of claim 13, wherein the quality index is calculated based on a quality factor corresponding to a pre-evaluation element and a Click-Through Rate (CTR) corresponding to a post evaluation element with respect to a listing of the advertisement.

15. The system of claim 13, wherein the quality index adjusting module adjusts, when the maximum quality index exceeds a predetermined multiple of the minimum quality index, each and every quality index in the advertisement region to be equal to or less than the predetermined multiple.

16. The system of claim 15, wherein each and every quality index in the advertisement region is adjusted to maintain a ratio of a difference between existing quality indexes.

17. The system of claim 15, wherein the quality index is adjusted with respect to advertisements displayed more than a reliable display number before a reference day and the reliable display number is calculated based on the average number of daily queries of a corresponding keyword and the average number of daily displays of the keyword.

18. The system of claim 13, wherein the advertisement providing module comprises:
a ranking index calculating module to calculate a ranking index of the advertisement based on a maximum click cost of the advertisement and the adjusted quality index; and
an advertisement displaying module to display the advertisement based on the ranking index.
